(19) United States
(12) Patent Application Publication
(10) Pub. No.: US 2025/0317718 A1
(43) Pub. Date: Oct. 9, 2025

(54) SENSING PROCESSING METHOD AND APPARATUS, COMMUNICATION DEVICE, AND READABLE STORAGE MEDIUM

(71) Applicant: VIVO MOBILE COMMUNICATION CO., LTD., Dongguan (CN)

(72) Inventors: Dajie JIANG, Dongguan (CN); Jianzhi LI, Dongguan (CN)

(73) Assignee: VIVO MOBILE COMMUNICATION CO., LTD., Dongguan (CN)

(21) Appl. No.: 19/246,469

(22) Filed: Jun. 23, 2025

Related U.S. Application Data
(63) Continuation of application No. PCT/CN2023/139335, filed on Dec. 18, 2023.

(30) Foreign Application Priority Data
Dec. 23, 2022 (CN) 202211668075.8

(51) Int. Cl. H04W 4/38; H04B 17/309; H04W 8/22; H04W 24/10

(52) U.S. Cl. CPC H04W 4/38; H04B 17/346; H04W 8/22; H04W 24/10

(57) ABSTRACT

A sensing processing method and apparatus, a communication device, and a readable storage medium are provided. The method includes: receiving, by a first device, a first result sent by at least one second device, where the first result includes a sensing measurement quantity obtained by the second device by measuring a first signal, from a third device, used for a sensing service. The method further includes performing, by the first device, first processing on at least two first results, to obtain a second result.

### CROSS-REFERENCE TO RELATED APPLICATIONS

This application is a continuation of International Application No. PCT/CN2023/139335, filed on Dec. 18, 2023, which claims priority to Chinese Patent Application No. 202211668075.8, filed on Dec. 23, 2022. The entire contents of each of the above-referenced applications are expressly incorporated herein by reference in its entirety.

### TECHNICAL FIELD

This application relates to the field of communication technologies, and specifically, to a sensing processing method and apparatus, a communication device, and a readable storage medium.

### BACKGROUND

In addition to a communication capability, a future mobile communication system, for example, a beyond fifth-generation (B5G) system or a sixth-generation (6G) system, has a sensing capability. The sensing capability is that one or more devices having the sensing capability can sense information such as a direction, a distance, and a speed of a target object by sending and receiving a wireless signal, or detect, track, identify, or image a target object, an event, an environment, or the like. In the future, with the deployment of a small base station having a capability of a high frequency band and a large bandwidth such as millimeter wave and terahertz in a 6G network, resolution of sensing is significantly improved when compared with that of a centimeter wave, so that the 6G network can provide a more precise sensing service.

Currently, how to improve sensing performance is an urgent problem to be resolved.

### SUMMARY

Embodiments of this application provide a sensing processing method and apparatus, a communication device, and a readable storage medium.

According to a first aspect, a sensing processing method is provided. The method includes:

A first device receives a first result sent by at least one second device, where the first result includes a sensing measurement quantity obtained by the second device by measuring a first signal, sent by at least one third device, used for a sensing service; and
the first device performs first processing on at least two first results, to obtain a second result.

According to a second aspect, a sensing processing method is provided. The method includes:
A second device obtains a first result, where the first result includes a sensing measurement quantity obtained by the second device by measuring a first signal, sent by at least one third device, used for a sensing service; and
the second device sends the first result to a first device, where the first result is used to obtain a second result through first processing.

According to a third aspect, a sensing processing apparatus is provided. The apparatus includes:
a first receiving module, configured to receive a first result sent by at least one second device, where the first result includes a sensing measurement quantity obtained by the second device by measuring a first signal, sent by at least one third device, used for a sensing service; and
a first processing module, configured to perform first processing on at least two first results, to obtain a second result.

According to a fourth aspect, a sensing processing apparatus is provided. The apparatus includes:
a first obtaining module, configured to obtain a first result, where the first result includes a sensing measurement quantity obtained by a second device by measuring a first signal, sent by at least one third device, used for a sensing service; and
a fourth sending module, configured to send the first result to a first device, where the first result is used to obtain a second result through first processing.

According to a fifth aspect, a communication device is provided. The communication device includes a processor, a memory, and a program or an instruction that is stored in the memory and that is executable on the processor. When the program or the instruction is executed by the processor, steps of the method according to the first aspect or the second aspect are implemented.

According to a sixth aspect, a readable storage medium is provided. The readable storage medium stores a program or an instruction; and when the program or the instruction is executed by a processor, steps of the method according to the first aspect or the second aspect are implemented.

According to a seventh aspect, a chip is provided. The chip includes a processor and a communication interface. The communication interface is coupled to the processor. The processor is configured to run a program or an instruction, to implement steps of the method according to the first aspect or the second aspect.

According to an eighth aspect, a computer program/program product is provided. The computer program/program product is stored in a non-transient storage medium, and the program/program product is executed by at least one processor, to implement steps of the method according to the first aspect or the second aspect.

According to a ninth aspect, a communication system is provided. The communication system includes a terminal and a network device, the terminal is configured to perform steps of the method according to the first aspect, and the network device is configured to perform steps of the method according to the second aspect.

In the embodiments of this application, the first device receives the first result sent by the at least one second device, where the first result includes the sensing measurement quantity obtained by the second device by measuring the first signal, sent by the at least one third device, used for the sensing service; and the first device performs first processing on the at least two first results, to obtain the second result, so that the at least one third device and the at least one second device participate in cooperative sensing, thereby effectively improving sensing performance.

### BRIEF DESCRIPTION OF DRAWINGS

FIG. 1 is a schematic diagram of integrated sensing and communication;

FIG. 2 is a schematic diagram of a sensing processing method according to an embodiment of this application;

FIG. 3 is a schematic diagram of a sensing processing method according to another embodiment of this application;

FIG. 4 is a schematic diagram of a sensing processing method according to still another embodiment of this application;

FIG. 5 is a schematic diagram of cooperative sensing;

FIG. 6 is a schematic diagram of calculating a one-dimensional graph SNR according to an embodiment of this application;

FIG. 7 is a diagram of a structure of a sensing processing apparatus according to an embodiment of this application;

FIG. 8 is a diagram of a structure of a sensing processing apparatus according to another embodiment of this application;

FIG. 9 is a schematic diagram of a terminal according to an embodiment of this application; and

FIG. 10 is a schematic diagram of a communication device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in this specification and the claims, “and/or” represents at least one of connected objects, and a character “/” generally represents an “or” relationship between associated objects.

It should be noted that the technologies described in the embodiments of this application are not limited to a Long Term Evolution (LTE)/LTE-Advanced (LTE-A) system, and may also be used in other wireless communication systems such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-carrier Frequency Division Multiple Access (SC-FDMA) system, and another system. The terms “system” and “network” in the embodiments of this application may be used interchangeably. The technologies described can be applied to both the systems and the radio technologies mentioned above as well as to other systems and radio technologies. A New Radio (NR) system is described in the following descriptions for illustrative purposes, and the NR terminology is used in most of the following descriptions, although these technologies can also be applied to applications other than the NR system application, such as a 6th Generation (6G) communication system.

To facilitate understanding of the embodiments of this application, the following technical points are introduced first.

### 1. Integrated Sensing and Communication.

In addition to a communication capability, a future mobile communication system, for example, a Beyond 5th Generation (B5G) mobile communication system or a sixth-generation (6G) mobile communication system, has a sensing capability. The sensing capability is that one or more devices having the sensing capability can sense information such as a direction, a distance, and a speed of a target object by sending and receiving a wireless signal, or detect, track, identify, or image a target object, an event, an environment, or the like. In the future, with the deployment of a small base station having a capability of a high frequency band and a large bandwidth such as millimeter wave and terahertz in a 6G network, resolution of sensing is significantly improved when compared with that of a centimeter wave, so that the 6G network can provide a more precise sensing service. A typical sensing function and an application scenario are shown in Table 1.

A typical sensing function and an application scenario are shown in Table 1.

TABLE 1
Typical sensing function and application scenario

| Communication | | |
|---|---|---|
| sensing category | Sensing function | Application scenario |
| Macro sensing | Weather conditions, air quality, and the like | Meteorology, agriculture, and life |
| type | | services |
| | Traffic flow (intersections) and flow of people | Intelligent traffic and commercial |
| | (subway entrances) | services |
| | Target tracking, ranging, speed measurement, | Many application scenarios for |
| | contours, and the like | conventional radars |
| | Environment reconstruction | Intelligent driving and navigation |
| | | (vehicles/uncrewed aerial vehicles), |
| | | smart city (3D map), and network |
| | | planning and optimization |
| Fine sensing | Action/posture/expression recognition | Intelligent interaction of smartphones, |
| type | | games, and smart home |
| | Heartbeat/breathing and the like | Health and medical care |
| | Imaging, material detection, component | Security inspection, industry, |
| | analysis, and the like | biological medicine, and the like |

Integrated sensing and communication (ISAC for short) means that in a same system, a design of integrated communication and sensing functions is implemented through spectrum sharing and hardware sharing. When information is transmitted, the system can sense information such as a direction, a distance, and a speed, and detect, track, and identify a target device or an event. A communication system and a sensing system cooperate with each other, to improve overall performance and bring better service experience.

Integrated radar and communication is typical application of integrated sensing and communication (fused sensing and communication). In the past, a radar system and a communication system have been strictly distinguished due to different study objects and concerns. In most scenarios, the two systems have been independently studied. In fact, the radar system and the communication system are also used as typical manners of information sending, obtaining, processing, and exchange, and have many similarities in terms of working principles, system architectures, and frequency bands. A design of the integrated radar and communication is quite feasible, which is mainly embodied in the following aspects: First, both the communication system and the sensing system are based on an electromagnetic wave theory, and transmission and reception of an electromagnetic wave are used to complete information obtaining and transmission.

Second, both the communication system and the sensing system have structures such as an antenna, a transmit end, a receive end, and a signal processor, and there is great overlap in hardware resources. With development of technologies, there is more overlap between the two in working frequency bands. In addition, there is a similarity in key technologies such as signal modulation and receiving detection, and waveform design. Fusion of the communication system and the radar system can bring many advantages, for example, saving costs, reducing a size, reducing power consumption, improving spectrum efficiency, and reducing mutual interference, so that overall system performance is improved.

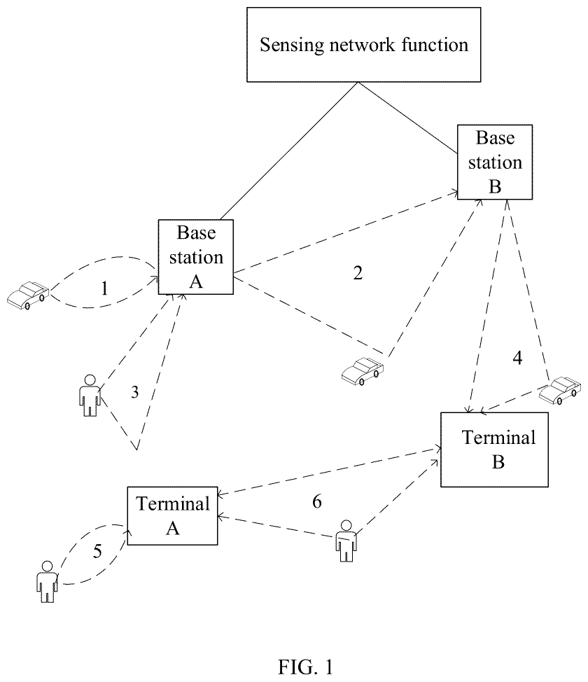

There are six basic sensing manners according to different sending nodes and receiving nodes of a sensing signal, as shown in FIG. 1, which includes:
(1) Base station echo sensing. In this sensing manner, a base station A sends a sensing signal, and performs sensing measurement by receiving an echo of the sensing signal.
(2) Inter-base station air interface sensing. A base station B receives a sensing signal sent by a base station A, and performs sensing measurement.
(3) Uplink air interface sensing. A base station A receives a sensing signal sent by a terminal A, and performs sensing measurement.
(4) Downlink air interface sensing. A terminal B receives a sensing signal sent by a base station B, and performs sensing measurement.
(5) Terminal echo sensing. A terminal A sends a sensing signal, and performs sensing measurement by receiving an echo of the sensing signal.
(6) Inter-terminal Sidelink (SL) sensing. A terminal B receives a sensing signal sent by a terminal A, and performs sensing measurement.

It should be noted that in FIG. 1, one sensing signal sending node and one sensing signal receiving node are used as an example in each sensing manner. In an actual system, one or more different sensing manners may be selected according to different sensing use cases and sensing requirements, and there may be one or more sending nodes and receiving nodes in each sensing manner. In FIG. 1, a person and a vehicle are used as an example of sensing targets, and it is assumed that neither the person nor the vehicle carries or installs a signal receiving/sending device. However, sensing targets in an actual scenario are more diverse.

The terminal in this application may be a terminal side device such as a mobile phone, a tablet personal computer, a laptop computer or a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, Vehicle User Equipment (VUE), Pedestrian User Equipment (PUE), a smart home (a home device with a wireless communication function, for example, a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, a game console, and the like. It should be noted that a specific type of the terminal is not limited in the embodiments of this application.

A first device, a second device, or a third device in this application may include a sensing network function or a sensing network element or a Sensing Management Function (Sensing MF). The first device, the second device, or the third device may be located on a Radio Access Network (RAN) side or a core network side, and is a network node that is responsible for at least one function of sensing request processing, sensing resource scheduling, sensing information exchange, sensing data processing, and the like. In some embodiments, the first device, the second device, or the third device may be upgraded based on an Access and Mobility Management Function (AMF) or a Location Management Function (LMF) in an existing 5G network, or may be another network node or a newly-defined network node.

A core network device in this application may include but is not limited to at least one of the following: a core network node, a core network function, a Mobility Management Entity (MME), an AMF, an LMF, a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that in the embodiments of this application, only a core network device in an NR system is used as an example for description, and a specific type of the core network device is not limited.

The sensing signal in this application may be a signal that has only a sensing function and does not include a communication function, for example, an existing LTE/NR synchronization signal or reference signal. This type of signal is based on a pseudo-random sequence, and includes one of the following: an m-sequence, a Zadoff-Chu sequence, a Gold sequence, and the like; or may be a single-frequency Continuous Wave (CW), a frequency modulated continuous wave (FMCW), an ultra-wideband Gauss pulse, and the like commonly used by radar; or may be a newly-designed dedicated sensing signal with a good correlation characteristic and a Peak to Average Power Ratio (PAPR), or a newly-designed integrated sensing and communication signal with a sensing function and a communication function. In the embodiments of this application, the foregoing sensing signal or the integrated sensing and communication signal is collectively referred to as a sensing signal.

With reference to the accompanying drawings, the following describes in detail, by using some embodiments and application scenarios thereof, a sensing processing method and apparatus, a communication device, and a readable storage medium provided in the embodiments of this application.

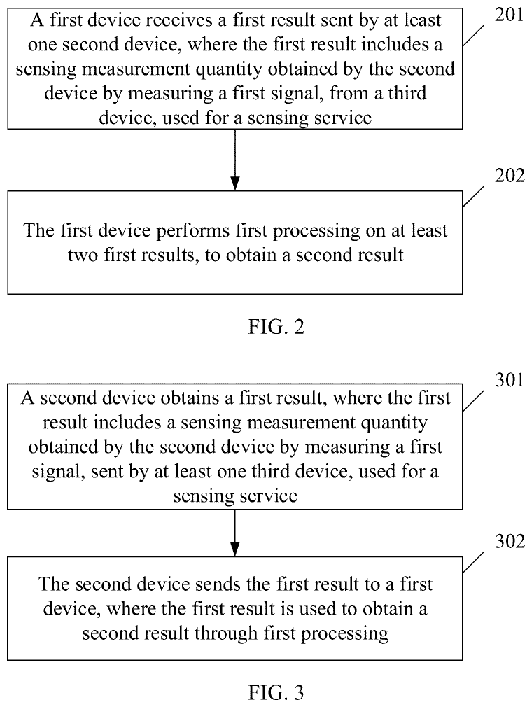

Referring to FIG. 2, an embodiment of this application provides a sensing processing method, applied to a first device. The first device may be a core network device, a base station, or a device that sends a first signal. The device that sends the first signal may be a terminal or a base station. Specific steps include step 201 and step 202.

Step 201: The first device receives a first result sent by at least one second device, where the first result includes a sensing measurement quantity obtained by the second device by measuring a first signal, from a third device, used for a sensing service.

The foregoing second device may be a device that receives the first signal. For example, the second device may be a base station, a terminal, or the like.

The first signal in this specification may also be referred to as a sensing signal or an integrated sensing and communication signal, that is, a sensing service may be supported by receiving the first signal. For example, the sensing measurement quantity or a sensing result may be obtained by receiving the first signal.

The first signal may be a signal that does not include transmission information, for example, an existing LTE/NR synchronization and reference signal; or the first signal may be at least one of a Synchronization Signal Block (SSB) signal, a Channel State Information-Reference Signal (CSI-RS), a Demodulation Reference Signal (DMRS), a Sounding Reference Signal (SRS), a Positioning Reference Signal (PRS), a Phase Tracking Reference Signal (PTRS), or the like; or the first signal may be a single-frequency Continuous Wave (CW), a frequency modulated continuous wave (FMCW), and an ultra-wideband Gauss pulse commonly used by radar; or the first signal may be a newly-designed dedicated signal with a good correlation characteristic and a low peak to average power ratio, or a newly-designed integrated sensing and communication signal that carries specific information and has better sensing performance. For example, the new signal is obtained by splicing/combining/superposing at least one dedicated sensing signal/reference signal and at least one communication signal in time domain and/or frequency domain.

Step 202: The first device performs first processing on at least two first results, to obtain a second result.

For example, the first processing includes at least one of the following:
(1) obtaining an average value of the at least two first results,
for example, calculating the average value of the at least two first results (for example, moving speeds) of a same sensing target or a same sensing area or a same sensing service, to obtain the second result;
(2) obtaining a weighted average value of the at least two first results,
for example, calculating the weighted average value of the at least two first results (for example, moving speeds) of a same sensing target or a same sensing area or a same sensing service, to obtain the second result;
(3) obtaining a value whose specified indicator is optimal in the at least two first results, where
the specified indicator may be measurement quantity indicator information (for example, a Signal-to-Noise Ratio (SNR) and a sensing SNR) corresponding to the first result; for example, for the at least two first results, such as moving speeds, of a same sensing target, a same sensing area, or a same sensing service, a moving speed with a highest sensing signal-to-noise and interference ratio (SINR) is selected, to obtain the second result;
(4) selecting, from the at least two first results associated with a same sensing target or a same sensing area or a same sensing service, first results corresponding to different sensing measurement quantities,
for example, selecting a moving speed of a same sensing target in a first result A and location information of the same sensing target in a first result B, to obtain the moving speed and location information of the same sensing target (namely, the second result);
(5) fusing the at least two first results associated with the same sensing target or the same sensing area or the same sensing service,
for example, measuring the at least two first results from different perspectives on the same sensing target, and fusing the at least two first results, to obtain a 360-degree measurement result, for example, 360-degree three-dimensional point cloud information (including a distance, a speed, and angle information), of the sensing target, as the second result.

In an implementation of this application, a determining manner of the at least two first results associated with the same sensing target or the same sensing area or the same sensing service includes at least one of the following:
in a global coordinate system or a same coordinate system, if location coordinates corresponding to the at least two first results are the same or similar, the at least two first results are associated with the same sensing target or the same sensing area or the same sensing service; or
in a global coordinate system or a same coordinate system, if location coordinates corresponding to the at least two first results are the same and corresponding moving speeds are the same or similar, the at least two first results are associated with the same sensing target or the same sensing area or the same sensing service.

In an implementation of this application, the method further includes:

The first device sends format information to the at least one second device, where the format information is used to indicate a format of the first result.

For example, the format information of the first result includes but is not limited to at least one of unified coordinate system information, a unified reference point/origin, or the like used for the first result, where a unified coordinate system may include X/Y/Z in a rectangular coordinate system, or a distance/an azimuth/a pitch angle in a polar coordinate system, or a longitude, a latitude, and an altitude.

In an implementation of this application, the method further includes:
The first device receives a confidence level of the first result sent by the at least one second device, where the confidence level of the first result is determined by the second device based on a sensing capability;
and/or
the first device receives at least one of sensing capability information, location information, and array orientation information sent by the at least one second device; and
the first device determines the confidence level of the first result based on at least one of the sensing capability information, the location information, and the array orientation information.

For example, resolution of the sensing target is different in different orientation arrays, and confidence levels of the corresponding first result are also different. For example, the sensing target is located in an antenna normal direction, and a confidence level of the first result corresponding to the sensing target is maximum.

In an implementation of this application, that the first device performs first processing on at least two first results, to obtain a second result includes:

In a case that the sensing measurement quantity or sensing performance corresponding to an operation result of the sensing measurement quantity meets a first preset condition, the first device performs first processing on the at least two first results, to obtain the second result.

For example, the sensing measurement quantity may include at least one of the following:
(a) a first-level measurement quantity (received signal/original channel information), where the first-level measurement quantity includes at least one of a received signal/channel response complex result, an amplitude/phase, and I channels/Q channels and operation results of the I channels/Q channels; and
the operation includes at least one of addition/subtraction/multiplication/division, matrix addition/subtraction/multiplication, matrix transposition, a triangular relationship operation, a square root operation, a power operation, a threshold detection result of the operation result, a maximum/minimum value extraction result, and the like; and the operation further includes at least one of Fast Fourier Transform (FFT)/Inverse Fast Fourier Transform (IFFT), Discrete Fourier Transform (DFT)/Inverse Discrete Fourier Transform (IDFT), 2D-FFT, 3D-FFT, matched filtering, autocorrelation calculation, wavelet transform, digital filtering, a threshold detection result of the operation result, a maximum/minimum value extraction result, and the like;
(b) a second-level measurement quantity (a basic measurement quantity), where the second-level measurement quantity may include at least one of a delay, Doppler, an angle, strength, and a multi-dimensional combination representation thereof;
(c) a third-level measurement quantity (a basic attribute/state), where the third-level measurement quantity may include at least one of a distance, a speed, an orientation, a spatial position, and acceleration; and
(d) a fourth-level measurement quantity (an advanced attribute/state), where the fourth-level measurement quantity may include at least one of whether a target exists, a trajectory, an action, an expression, a vital sign, a quantity, an imaging result, weather, air quality, a shape, a material, and a composition.

For example, the sensing measurement quantity further includes tag information corresponding to the sensing measurement quantity, where the tag information may include at least one of the following:
(1) sensing signal identification information;
(2) sensing measurement configuration identification information;
(3) sensing service information, for example, a sensing service identifier (ID);
(4) a data subscription ID;
(5) measurement quantity usage, for example, communication, sensing, and sensing and communication;
(6) time information;
(7) sensing node information, for example, a terminal ID, a node location, and a device orientation;
(8) sensing link information, for example, a sensing link sequence number and a transceiver node identifier, where
for example, the sensing link information includes an identifier of a receive antenna or a receive channel; and if the sensing link information is a sensing measurement quantity of a single receive antenna or a single receive channel, the identifier is an identifier of the receive antenna or the receive channel; or if the sensing link information is a result of division or conjugate multiplication of two receive antennas or receive channels, the identifier is an identifier of the two receive antennas or receive channels and an identifier of division or conjugate multiplication;
(9) measurement quantity description information,
for example, a measurement quantity form, for example, an amplitude value, a phase value, a complex value combining an amplitude and a phase; and a measurement quantity resource type, for example, a time domain measurement result and a frequency domain resource measurement result; and
(10) measurement quantity indicator information, for example, an SNR and a sensing SNR.

For example, the sensing performance includes at least one of the following:
(1) Power value of a sensing target association signal component,
for example, may be a power value of a sensing path.

It should be noted that the power value of the sensing target association signal component is a signal component power that is greatly affected by a sensing target in the received first signal, and may be at least one of the following:

A1011. A power value calculated by using an amplitude corresponding to a sample point with a largest amplitude in a frequency domain channel response of the received first signal as a target amplitude, a power value calculated by using an amplitude corresponding to a plurality of sample points with a largest amplitude as a target amplitude, a power value calculated by using an amplitude of a sample point corresponding to a specified subcarrier or Physical Resource Block (PRB) as a target amplitude, or a power value calculated by using an amplitude of sample points corresponding to a plurality of specified subcarriers or PRBs as a target amplitude.

A1012. A power value calculated by using an amplitude corresponding to a sample point with a largest amplitude in an inverse Fourier transform (IFFT) result (delay domain) of a frequency domain channel response of the received first signal as a target amplitude, or a power value calculated by using an amplitude corresponding to a plurality of sample points with a largest amplitude as a target amplitude; or
a power value calculated by using an amplitude corresponding to a sample point with a largest amplitude within a specific delay range as a target amplitude, or a power value calculated by using an amplitude corresponding to a plurality of sample points with a largest amplitude as a target amplitude.

A1013. A power value calculated by using an amplitude corresponding to a sample point with a largest amplitude in a Fourier transform (FFT) result (Doppler domain) of a time domain channel response of the received first signal as a target amplitude, or a power value calculated by using an amplitude corresponding to a plurality of sample points with a largest amplitude as a target amplitude; or
a power value calculated by using an amplitude corresponding to a sample point with a largest amplitude within a specific Doppler range as a target amplitude, or a power value calculated by using an amplitude corresponding to a plurality of sample points with a largest amplitude as a target amplitude.

A1014. A power value calculated by using an amplitude corresponding to a sample point with a largest amplitude in a two-dimensional Fourier transform result, namely, a delay-Doppler domain result, of a channel response of the received first signal as a target amplitude, or a power value calculated by using an amplitude corresponding to a plurality of sample points with a largest amplitude as a target amplitude; or
a power value calculated by using an amplitude corresponding to a sample point with a largest amplitude within a specific delay-Doppler range as a target amplitude, or a power value calculated by using an amplitude corresponding to a plurality of sample points with a largest amplitude as a target amplitude.

It should be noted that the largest amplitude may, for example, mean that an amplitude exceeds a specific threshold, where the specific threshold may be indicated by a network side device, or may be calculated by the terminal according to a noise power and/or an interference power.

The specific delay/Doppler range is related to a sensing requirement, and may be indicated by the network side device, or may be obtained by the terminal according to the sensing requirement.

Radar detection is used as an example. The power value of the sensing target association signal component is an echo power, and a method for obtaining an echo signal power may be at least one of the following options:

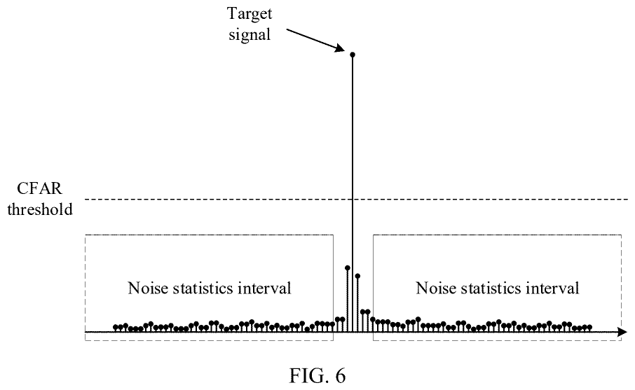

B11. Perform Constant False-Alarm Rate (CFAR) detection based on a one-dimensional delay graph obtained by performing fast time-dimensional fast Fourier transform (FFT) processing on an echo signal, where a sample point with a largest amplitude and a CFAR exceeding a threshold is used as a target sample point and an amplitude of the target sample point is used as a target signal amplitude, as shown in FIG. 6.

B12. Perform CFAR detection based on a one-dimensional Doppler graph obtained by performing slow time-dimensional FFT processing on an echo signal, where a sample point with a largest amplitude and a CFAR exceeding a threshold is used as a target sample point and an amplitude of the target sample point is used as a target signal amplitude.

B13. Perform CFAR detection based on a two-dimensional delay-Doppler graph obtained by performing 2D-FFT processing on an echo signal, where a sample point with a largest amplitude and a CFAR exceeding a threshold is used as a target sample point and an amplitude of the target sample point is used as a target signal amplitude.

B14. Perform CFAR detection based on a three-dimensional delay-Doppler-angle graph obtained by performing 3D-FFT processing on an echo signal, where a sample point with a largest amplitude and a CFAR exceeding a threshold is used as a target sample point and an amplitude of the target sample point is used as a target signal amplitude.

It should be noted that in addition to a method for determining the target signal amplitude by using the sample point with the largest amplitude and the CFAR exceeding the threshold as the target sample point, an average value of the sample point with the largest amplitude and the CFAR exceeding the threshold and nearest several sample points exceeding the threshold may be used as the target signal amplitude.
(2) Sensing signal-to-noise ratio (SNR), where
for example, the sensing SNR may be a ratio of the power value of the sensing target association signal component to a noise power.
(3) Sensing SINR, where
for example, the sensing SINR may be a ratio of the power value of the sensing target association signal component to a sum of a noise power and an interference power.

In some embodiments, a method for obtaining the SNR/SINR may be as follows:

B21. Perform constant false-alarm rate (CFAR) detection based on a one-dimensional delay graph obtained by performing fast time-dimensional FFT processing on an echo signal, where a sample point with a largest amplitude and a CFAR exceeding a threshold is used as a target sample point, an amplitude of the target sample point is used as a target signal amplitude, all sample points except ±ε sample points separated from the target sample point in the one-dimensional graph are used as interference/noise sample points, an average interference/amplitude is counted as an interference/noise signal amplitude, and finally, the SNR/SINR is calculated by using the target signal amplitude and the interference/noise signal amplitude.

B22. Perform CFAR detection based on a one-dimensional Doppler graph obtained by performing slow time-dimensional FFT processing on an echo signal, where a sample point with a largest amplitude and a CFAR exceeding a threshold is used as a target sample point, an amplitude of the target sample point is used as a target signal amplitude, all sample points except En sample points separated from the target sample point in the one-dimensional graph are used as interference/noise sample points, an average amplitude is counted as an interference/noise signal amplitude, and finally, the SNR/SINR is calculated by using the target signal amplitude and the interference/noise signal amplitude.

B23. Perform CFAR detection based on a two-dimensional delay-Doppler graph obtained by performing 2D-FFT processing on an echo signal, where a sample point with a largest amplitude and a CFAR exceeding a threshold is used as a target sample point, an amplitude of the target sample point is used as a target signal amplitude, all sample points except ±ε (fast time-dimensional) and ±η (slow time-dimensional) sample points separated from the target sample point in the two-dimensional graph are used as interference/noise sample points, an average amplitude is counted as an interference/noise signal amplitude, and finally, the SNR/SINR is calculated by using the target signal amplitude and the interference/noise signal amplitude.

B24. Perform CFAR detection based on a three-dimensional delay-Doppler-angle graph obtained by performing 3D-FFT processing on an echo signal, where a sample point with a largest amplitude and a CFAR exceeding a threshold is used as a target sample point, an amplitude of the target sample point is used as a target signal amplitude, all sample points except ±ε (fast time-dimensional), ±η (slow time-dimensional), and ±δ (angle-dimensional) sample points separated from the target sample point in the three-dimensional graph are used as interference/noise sample points, an average amplitude is counted as an interference/noise signal amplitude, and finally, the SNR/SINR is calculated by using the target signal amplitude and the interference/noise signal amplitude.

It should be noted that, in addition to a manner for determining the target signal amplitude by using the sample point with the largest amplitude and the CFAR exceeding the threshold as the target sample point, an average value of the sample point with the largest amplitude and the CFAR exceeding the threshold and nearest several sample points exceeding the threshold may be used as the target signal amplitude.

It should be noted that a manner for determining an interference/noise sample point may, for example, be to perform further screening based on the foregoing determined interference/noise sample points, where a screening manner is as follows: For the one-dimensional delay graph, several sample points near a delay being 0 are removed, and a remaining interference/noise sample point is used as the noise sample point. For the one-dimensional Doppler graph, several sample points near Doppler being 0 are removed, and a remaining interference/noise sample point is used as the interference/noise sample point. For the two-dimensional delay-Doppler graph, several points near a delay being 0 and interference/noise sample points within a strip range formed by all Doppler ranges are removed, and a remaining noise sample point is used as the interference/noise sample point. For the three-dimensional delay-Doppler-angle graph, several points near a time dimension 0 and interference/noise sample points within a slice range formed by all Doppler ranges and all angle ranges are removed, and a remaining interference/noise sample point is used as the interference/noise sample point.
(4) Whether a sensing target exists, where
for example, whether the sensing target exists may include at least one of the following:
whether a sensing target within a speed or Doppler preset range exists; and
whether a sensing target within a distance or delay preset range exists.
(5) Target quantity of sensing targets, where
for example, the target quantity of sensing targets may include at least one of the following:
a target quantity of sensing targets within the speed or Doppler preset range; and
a target quantity of sensing targets within the distance or delay preset range.

It should be noted that A104 and A105 mentioned above may be notified to the terminal by another device (for example, another terminal, an access network device, or a core network device) according to a sensing requirement.

It should be noted that a manner for determining whether the sensing target exists may be: for example, whether a sample point whose amplitude exceeds a specific threshold exists in the one-dimensional or two-dimensional delay/Doppler graph. If the sample point exists, it is considered that the sensing target is detected, and a quantity of sample points whose amplitude exceeds the specific threshold in the one-dimensional or two-dimensional delay/Doppler graph is considered as a quantity of sensing targets.
(6) Radar Cross Section (RCS) information of the sensing target, where
it should be noted that the RCS information may be RCS information of a single sensing target, or may be RCS information of a plurality of sensing targets.
(7) Spectral information of the sensing target, where
it should be noted that the spectral information may include at least one of the following: a delay power spectrum, a Doppler power spectrum, a delay/distance-Doppler/speed spectrum, an angle power spectrum, a delay/distance-angle spectrum, a Doppler/speed-angle spectrum, and a delay/distance-Doppler/speed-angle spectrum.
(8) Delay of at least one sensing target.
(9) Distance of the at least one sensing target.
(10) Doppler of the at least one sensing target.
(11) Speed of the at least one sensing target.
(12) Angle information of the at least one sensing target.

For example, that the sensing measurement quantity or the sensing performance meets the first preset condition includes at least one of the following:
(1) a power value of a sensing target association signal component meets a first threshold, where for example, a power value of a sensing target association signal component corresponding to an operation result (or another operation result) of division or conjugate multiplication performed on a sensing measurement quantity on two receive antennas/receive channels meets the first threshold;
(2) a sensing SNR meets a second threshold;
(3) a sensing SINR meets a third threshold;
(4) at least Y sensing targets are detected, where
Y is a positive integer; and
it may be understood that the first threshold, the second threshold, and the third threshold are not limited in this embodiment;
(5) a bitmap corresponding to a sensing target determined based on detection is consistent with a preset bitmap configured by a network side device;
(6) an RCS of the sensing target meets a third preset condition, where for example, the RCS of the sensing target meets the third preset condition; and for example, the third preset condition is that the RCS reaches X square meters, and X is a positive real number;
(7) spectral information of the sensing target meets a fourth preset condition, where for example, the spectral information of the sensing target meets the fourth preset condition: for example, a distance-speed spectrum of the sensing target meets the fourth preset condition, where the fourth preset condition herein is that the sensing target can be distinguished on the distance-speed spectrum (an amplitude of a point or an area on the distance-speed spectrum reaches a preset value or an amplitude is the largest); or a delay-Doppler spectrum of the sensing target meets the fourth preset condition, where the fourth preset condition herein is that the sensing target can be distinguished on the delay-Doppler spectrum (an amplitude of a point or an area on the delay-Doppler spectrum reaches a preset value or an amplitude is the largest); and
(8) a first parameter of the sensing target meets a fifth preset condition, and the first parameter includes at least one of the following: a delay, a distance, Doppler, a speed, and angle information, where for example, the first parameter of the sensing target meets the fifth preset condition: for example, the delay of the sensing target meets the fifth preset condition (for example, the delay meets an interval value); for another example, the distance of the sensing target meets the fifth preset condition (for example, the distance meets an interval value); for another example, the Doppler of the sensing target meets the fifth preset condition (for example, the Doppler meets an interval value); for another example, the speed of the sensing target meets the fifth preset condition (for example, the speed meets an interval value); and for another example, the angle information of the sensing target meets the fifth preset condition (for example, the angle information meets an interval value).

In an implementation of this application, after that the first device performs first processing on at least two first results, to obtain a second result, the method further includes: The first device sends the second result to a core network device.

In an implementation of this application, after that the first device receives a first result sent by at least one second device, the method further includes:

The first device broadcasts sensing node information used to receive and/or send the first signal.

For example, the first device may re-broadcast the sensing node information used to receive and/or send the first signal. In this way, some sensing nodes with low confidence levels may quit cooperative sensing, or a new sensing node may be re-selected to participate in cooperative sensing, to reduce overheads and computing power.

In an implementation of this application, the second device or the third device is associated with at least one sensing manner, and the sensing manner includes at least one of base station self-sending and self-receiving sensing, inter-base station air interface sensing, uplink air interface sensing, downlink air interface sensing, terminal self-sending and self-receiving sensing, and an inter-terminal sidelink sensing.

In this embodiment of this application, the first device receives the first result sent by the at least one second device, where the first result includes the sensing measurement quantity obtained by the second device by measuring the first signal, sent by the at least one third device, used for the sensing service; and the first device performs first processing on the at least two first results, to obtain the second result, so that the at least one third device and the at least one second device participate in cooperative sensing, thereby effectively improving sensing performance.

Referring to FIG. 3, an embodiment of this application provides a sensing processing method, applied to a second device. The second device may be a device that receives a first signal. For example, the second device may be a base station or a terminal. Specific steps include step 301 and step 302.

Step 301: The second device obtains a first result, where the first result includes a sensing measurement quantity obtained by the second device by measuring a first signal, sent by at least one third device, used for a sensing service.

Step 302: The second device sends the first result to a first device, where the first result is used to obtain a second result through first processing.

For example, before measuring the first signal to obtain the first result, the method further includes:

The second device performs second processing on the first signal, where
the second processing includes at least one of the following:
(1) processing based on a preset sensing algorithm, where
for example, the sensing algorithm includes but is not limited to a Multiple Signal Classification (MUSIC) algorithm and the like;
(2) performing clutter elimination on a static object, where
for example, a clutter generated by a static object at a preset location is eliminated, where the preset location may be notified by another device to the first device;
(3) performing clutter elimination on a dynamic non-sensing target, where
for example, a clutter generated by a preset dynamic object is eliminated, where the preset dynamic object is a non-sensing target, and a feature of the preset dynamic object, for example, a Doppler range or a moving speed range, is notified by another device to the first device; and
(4) aligning first paths of the first signal received by a plurality of antennas of the second device.

For example, a specific manner of the second processing and a sensing measurement quantity related to the second processing may be notified by another device to the second device. For example, a core network device notifies a base station (the second device) or a base station notifies UE (the second device).

In an implementation of this application, the first processing includes at least one of the following:
(1) obtaining an average value of at least two first results;
(2) obtaining a weighted average value of the at least two first results;
(3) obtaining a value whose specified indicator is optimal in the at least two first results;
(4) selecting, from the at least two first results associated with a same sensing target or a same sensing area or a same sensing service, first results corresponding to different sensing measurement quantities; and
(5) fusing the at least two first results associated with the same sensing target or the same sensing area or the same sensing service.

In an implementation of this application, a determining manner of the at least two first results associated with the same sensing target or the same sensing area or the same sensing service includes at least one of the following:
in a global coordinate system or a same coordinate system, if location coordinates corresponding to the at least two first results are the same or similar, the at least two first results are associated with the same sensing target or the same sensing area or the same sensing service; or
in a global coordinate system or a same coordinate system, if location coordinates corresponding to the at least two first results are the same and corresponding moving speeds are the same or similar, the at least two first results are associated with the same sensing target or the same sensing area or the same sensing service.

In an implementation of this application, the method further includes:

The second device receives format information sent by the first device, where the format information is used to indicate a format of the first result.

In an implementation of this application, the method further includes:
The second device determines a confidence level of the first result based on a sensing capability;
the second device sends the confidence level of the first result to the first device;
and/or
the second device sends at least one of sensing capability information, location information, and array orientation information of the second device to the first device, where at least one of the sensing capability information, the location information, and the array orientation information is used to determine the confidence level of the first result.

In an implementation of this application, that the second device sends the first result to a first device includes:

In a case that the sensing measurement quantity or sensing performance corresponding to an operation result of the sensing measurement quantity meets a second preset condition, the second device sends the first result to the first device.

It should be noted that in this application, sensing measurement quantities corresponding to the second preset condition and the first preset condition or operation results of the sensing measurement quantities or sensing performance may be the same or different.

For example, that the sensing measurement quantity or the sensing performance meets the second preset condition includes at least one of the following:
(1) a power value of a sensing target association signal component meets a fourth threshold, where for example, a power value of a sensing target association signal component corresponding to an operation result (or another operation result) of division or conjugate multiplication performed on a sensing measurement quantity on two receive antennas/receive channels meets the fourth threshold;
(2) a sensing SNR meets a fifth threshold;
(3) a sensing SINR meets a sixth threshold, where
it may be understood that the fourth threshold, the fifth threshold, and the sixth threshold are not limited in this embodiment;
(4) at least Z sensing targets are detected, where
Z is a positive integer;
(5) a bitmap corresponding to a sensing target determined based on detection is consistent with a preset bitmap configured by a network side device;
(6) an RCS of the sensing target meets a sixth preset condition, where for example, the RCS of the sensing target meets the sixth preset condition; and for example, the sixth preset condition is that the RCS reaches X square meters, and X is a positive real number;
(7) spectral information of the sensing target meets a seventh preset condition, where for example, the spectral information of the sensing target meets the seventh preset condition: for example, a distance-speed spectrum of the sensing target meets the seventh preset condition, where the seventh preset condition herein is that the sensing target can be distinguished on the distance-speed spectrum (an amplitude of a point or an area on the distance-speed spectrum reaches a preset value or an amplitude is the largest); or a delay-Doppler spectrum of the sensing target meets the seventh preset condition, where the seventh preset condition herein is that the sensing target can be distinguished on the delay-Doppler spectrum (an amplitude of a point or an area on the delay-Doppler spectrum reaches a preset value or an amplitude is the largest); and
(8) a first parameter of the sensing target meets an eighth preset condition, and the first parameter includes at least one of the following: a delay, a distance, Doppler, a speed, and angle information, where for example, a second parameter of the sensing target meets the eighth preset condition: for example, the delay of the sensing target meets the eighth preset condition (for example, the delay meets an interval value); for another example, the distance of the sensing target meets the eighth preset condition (for example, the distance meets an interval value); for another example, the Doppler of the sensing target meets the eighth preset condition (for example, the Doppler meets an interval value); for another example, the speed of the sensing target meets the eighth preset condition (for example, the speed meets an interval value); and for another example, the angle information of the sensing target meets the eighth preset condition (for example, the angle information meets an interval value).

In an implementation of this application, the method further includes:

The second device receives first signaling, where the first signaling indicates at least one of the following:
(1) the first signal received by the second device;
(2) parameter configuration information of the first signal;
(3) the sensing measurement quantity of the first signal;
(4) tag information corresponding to the sensing measurement quantity of the first signal; and
(5) reporting configuration information of the first signal.

In an implementation of this application, the second device or the third device is associated with at least one sensing manner, and the sensing manner includes at least one of base station self-sending and self-receiving sensing, inter-base station air interface sensing, uplink air interface sensing, downlink air interface sensing, terminal self-sending and self-receiving sensing, and inter-terminal sidelink sensing.

In this embodiment of this application, the second device obtains the first result, where the first result includes the sensing measurement quantity obtained by the second device by measuring the first signal, sent by the at least one third device, used for the sensing service; and the second device sends the first result to the first device, where the first result is used to obtain the second result through first processing, so that the at least one third device and the at least one second device participate in cooperative sensing, thereby effectively improving sensing performance.

Embodiment 1: An embodiment of cooperative sensing of a plurality of sensing devices/a plurality of sensing manners.

In this embodiment, a third device is a device that sends a first signal, and a second device is a device that receives the first signal.

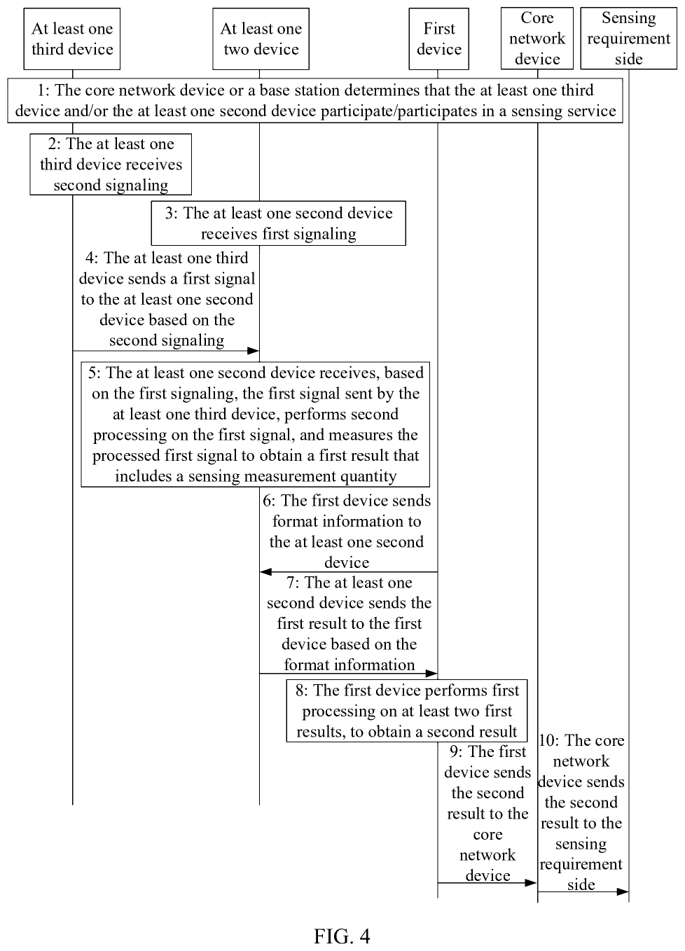

Referring to FIG. 4, example steps include the following:

Step 1: A core network device or a base station may determine, according to a sensing requirement, that at least one third device and/or at least one second device participate/participates in a sensing service.

Participating in the sensing service in this specification is receiving and/or sending the first signal.

For example, the third device and the second device may be a base station, a terminal, or the like.

For example, sensing requirement information including at least one of the following:
(1) a sensing service type: divided by type or specific to a service, such as imaging, positioning or trajectory tracking, motion recognition, ranging/speed measurement;
(2) a sensing target area: is a location area in which a sensing object may be present, or a location area that requires imaging or environmental reconstruction;
(3) a sensing object type: a sensing object is classified according to a possible motion characteristic of the sensing object, and each sensing object type includes information such as a motion speed, motion acceleration, and a typical RCS of a typical sensing object;
(4) sensing QoS: a performance indicator for sensing the sensing target area or the sensing object includes at least one of the following:
(41) sensing resolution, including at least one of the following: ranging (or delay) resolution, speed (or Doppler) measurement resolution, angle (azimuth and pitch angle) measurement resolution, imaging resolution, acceleration (three directions X/Y/Z) resolution, and angular velocity (around three axes X/Y/Z) resolution;
(42) sensing accuracy (error), including at least one of the following: ranging (or delay) accuracy, speed (or Doppler) measurement accuracy, angle (azimuth and pitch angle) measurement accuracy, acceleration (three directions X/Y/Z) accuracy, and angular velocity (around three axes X/Y/Z) accuracy;
(43) a sensing range, including at least one of the following: a distance (or delay) measurement range, a speed (or Doppler) measurement range, an acceleration (three directions X/Y/Z) measurement range, an angular velocity (around three axes X/Y/Z) measurement range, and an imaging range;
(44) a sensing delay (which is a time interval from sending of a sensing signal to obtaining of a sensing result, or a time interval from initiating of a sensing requirement to obtaining of a sensing result);
(45) a sensing update rate (which is a time interval at which two consecutive times of executing sensing and obtaining a sensing result);
(46) a detection probability (which is a probability of correctly detecting a sensing object in a case that the sensing object is present);
(47) a false alarm probability (which is a probability of incorrectly detecting a sensing target in a case that the sensing object is absent);
(48) a target quantity; and
(49) coverage: a spatial range of a sensing target/imaging area that meets at least one of the foregoing performance requirements; and
(50) sensing prior information, including at least one of the following:
(51) prior information of a spatial location at which a sensing object may present;
(52) prior information, for example, a spatial structure and a surface material of a sensing target area; and
(53) prior information of a radar characteristic of a sensing object, for example, a Radar Cross Section (RCS) size/pattern and a micro Doppler characteristic of the sensing object.

For example, in step 1, the core network device or the base station may determine, according to location information and/or sensing capability information of a sensing node/sensing device, the at least one first device and/or the at least one second device that participate/participates in the sensing service.

For example, the sensing capability information is used to indicate a hardware and/or software capability that the sensing node has, to support the corresponding sensing service.

For example, the sensing capability information includes two items: a supported measurement quantity and QoS of the supported measurement quantity.

For example, the supported measurement quantity includes at least one of the following:
(1) a first-level measurement quantity (received signal/original channel information), where the first-level measurement quantity includes at least one of a received signal/channel response complex result, an amplitude/phase, and I channels/Q channels and operation results of the I channels/Q channels; and
the operation includes at least one of addition/subtraction/multiplication/division, matrix addition/subtraction/multiplication, matrix transposition, a triangular relationship operation, a square root operation, a power operation, a threshold detection result of the operation result, a maximum/minimum value extraction result, and the like; and the operation further includes at least one of Fast Fourier Transform (FFT)/Inverse Fast Fourier Transform (IFFT), Discrete Fourier Transform (DFT)/Inverse Discrete Fourier Transform (IDFT), 2D-FFT, 3D-FFT, matched filtering, autocorrelation calculation, wavelet transform, digital filtering, a threshold detection result of the operation result, a maximum/minimum value extraction result, and the like;
(2) a second-level measurement quantity (a basic measurement quantity), where the second-level measurement quantity may include at least one of a delay, Doppler, an angle, strength, and a multi-dimensional combination representation thereof;
(3) a third-level measurement quantity (a basic attribute/state), where the third-level measurement quantity may include at least one of a distance, a speed, an orientation, a spatial position, and acceleration; and
(4) a fourth-level measurement quantity (an advanced attribute/state), where the fourth-level measurement quantity may include at least one of whether a target exists, a trajectory, an action, an expression, a vital sign, a quantity, an imaging result, weather, air quality, a shape, a material, and a composition.

For example, for any supported measurement quantity, the QoS of the supported measurement quantity includes at least one of the following:
(1) sensing resolution, including at least one of the following: ranging (or delay) resolution, speed (or Doppler) measurement resolution, angle (azimuth and pitch angle) measurement resolution, imaging resolution, acceleration (three directions X/Y/Z) resolution, and angular velocity (around three axes X/Y/Z) resolution;
(2) sensing accuracy (error), including at least one of the following: ranging (or delay) accuracy, speed (or Doppler) measurement accuracy, angle (azimuth and pitch angle) measurement accuracy, acceleration (three directions X/Y/Z) accuracy, and angular velocity (around three axes X/Y/Z) accuracy;
(3) a sensing range, including at least one of the following: a distance (or delay) measurement range, a speed (or Doppler) measurement range, an acceleration (three directions X/Y/Z) measurement range, an angular velocity (around three axes X/Y/Z) measurement range, and an imaging range;
(4) a sensing delay (which is a time interval from sending of the first signal to obtaining of a sensing result, or a time interval from initiating of a sensing requirement to obtaining of a sensing result);
(5) a sensing update rate (which is a time interval at which two consecutive times of executing sensing and obtaining a sensing result);
(6) a detection probability (which is a probability of correctly detecting a sensing object in a case that the sensing object is present);
(7) a false alarm probability (which is a probability of incorrectly detecting a sensing target in a case that the sensing object is absent);
(8) a target quantity; and
(9) coverage: a spatial range of a sensing target/imaging area that meets at least one of the foregoing performance requirements.

For example, each first device or each second device is associated with at least one of the following six sensing manners:
(1) base station self-sending and self-receiving sensing, where for example, a base station A sends a sensing signal, and performs sensing measurement by receiving an echo of the sensing signal; and both the third device and the second device are the base station A.
(2) inter-base station air interface sensing, where for example, a base station B receives a sensing signal sent by a base station A, and performs sensing measurement; and the third device is the base station A, and the second device is the base station B;
(3) uplink air interface sensing, where for example, a base station A receives a sensing signal sent by a terminal A, and performs sensing measurement; and the third device is the terminal A, and the second device is the base station A;
(4) downlink air interface sensing, where for example, a terminal B receives a sensing signal sent by a base station B, and performs sensing measurement; and the third device is the base station B, and the second device is the terminal B;
(5) terminal self-sending and self-receiving sensing, where for example, a terminal A sends a sensing signal, and performs sensing measurement by receiving an echo of the sensing signal; and both the third device and the second device are the terminal A; and
(6) inter-terminal sidelink sensing, where for example, a terminal B receives a sensing signal sent by a terminal A, and performs sensing measurement; and the third device is the terminal A, and the second device is the terminal B.

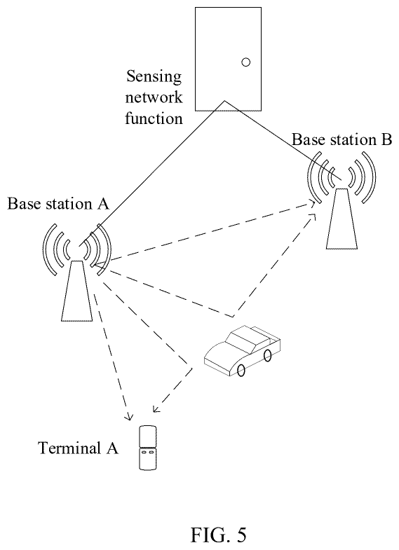

Referring to FIG. 5, a base station A sends a sensing signal and a base station B receives the sensing signal, and a base station A sends a sensing signal and a terminal A receives the sensing signal, to perform cooperative sensing on a sensing target (for example, a vehicle).

Step 2: The at least one third device receives second signaling.

For example, if the third device is a base station, the second signaling is sent by the core network device or another base station to the third device; or if the third device is a terminal, the second signaling is sent by the core network device, the base station, or another terminal to the third device.

For example, the second signaling is used to indicate one or more third devices to separately send a first signal to one or more second devices.

For example, the second signaling is further used to indicate parameter configuration information of the first signal.

For example, the first signals sent by the plurality of third devices may be signals of different frequencies. For example, a first signal sent by a third device A is a millimeter-wave signal of 28 GHz, and a first signal sent by a third device B is a centimeter-wave signal of 3.5 GHz.

For example, the first signals sent by the plurality of third devices may be signals of different waveforms. For example, a first signal sent by a third device A is a signal based on Orthogonal Frequency Division Multiplexing (OFDM), and a first signal sent by a third device B is a signal based on a (Frequency Modulated Continuous Wave (FMCW).

Step 3: The second device receives first signaling.

For example, the first signaling is used to indicate one or more of the following:
(1) the first signal received by the one or more second devices;
(2) parameter configuration information of the first signal;
(3) tag information corresponding to the sensing measurement quantity of the first signal; and
(4) reporting configuration information of the first signal.

It should be noted that the second device may receive one piece of first signaling, and the first signaling indicates (1) to (4) above; or the second device may receive a plurality of pieces of first signaling, and each piece of first signaling indicates some content in (1) to (4) above.

For example, the parameter configuration information of the first signal includes at least one of the following:
(1) a waveform type, for example, OFDM, SC-FDMA, OTFS, a frequency modulated continuous wave FMCW, and a pulse signal;
(2) a subcarrier spacing, for example, a subcarrier spacing 30 kHz of an OFDM system;
(3) a guard interval: a time interval between a moment at which sending of a signal ends and a moment at which a latest echo signal of the signal is received, where this parameter is proportional to a maximum sensing distance; for example, the guard interval may be calculated through 2dₘₐₓ/c, where dₘₐₓ represents the maximum sensing distance (which belongs to a sensing requirement); for example, for a sensing signal sent and received by itself, dₘₐₓ represents a maximum distance between a receiving point of the sensing signal and a signal transmission point; and in some cases, a cyclic prefix (CP) of an OFDM signal may serve as a minimum guard interval;
(4) a bandwidth, where this parameter is inversely proportional to distance resolution, and may be obtained by using c/2Δd, where Δd is the distance resolution (which belongs to a sensing requirement), and c is a speed of light;
(5) burst duration, where this parameter is inversely proportional to rate resolution (which belongs to a sensing requirement), and the parameter is a time span of the sensing signal and is mainly used to calculate a Doppler frequency shift; and the parameter may be calculated by using c/2f_{c}Δv, where Δv is speed resolution, and f_{c} is a carrier frequency of the sensing signal;
(6) a time domain interval, where this parameter may be calculated by using c/2f_{c}v_{range}, where v_{range} is a maximum rate minus a minimum speed (which belongs to a sensing requirement), and the parameter is a time interval between two adjacent sensing signals;
(7) a sending signal power, for example, a value taken at an interval of 2 dBm from −20 dBm to 23 dBm;
(8) a signal format, for example, an SRS, a DMRS, and a PRS, or information such as another predefined signal and a related sequence format;
(9) a signal direction, for example, direction or beam information of the sensing signal;
(10) a time resource, for example, an index of a slot in which the sensing signal is located or a symbol index of the slot, where the time resource is classified into two types, one is a one-time time resource, for example, an omnidirectional sensing signal is sent on a symbol, and the other is a non-one-time time resource, for example, a plurality of groups of periodic time resources or discontinuous time resources (which may include start time and end time), each group of periodic time resources is used to send sensing signals in a same direction, and beam directions on different groups of periodic time resources are different;
(11) a frequency resource, including a center frequency, a bandwidth, a resource block (Resource block, RB) or a subcarrier, a point A, a start bandwidth location, or the like of the sensing signal;
(12) a Quasi co-location (QCL) relationship, where for example, the sensing signal includes a plurality of resources, each resource corresponds to one SSB QCL, and the QCL includes Type A, B, C, or D; and
(13) antenna configuration information for the sensing node (the base station or the UE) includes at least one of the following:
(131) an antenna array element ID or an antenna port ID used to send and/or receive a sensing signal;
(132) a panel ID+an array element ID used to send and/or receive the sensing signal;
(133) location information of an antenna array element used to send and/or receive the sensing signal relative to a local reference point on an antenna array (which may be represented by Cartesian coordinates (x, y, z) or spherical coordinates (ρ, φ, θ));
(134) location information of a panel used to send and/or receive the sensing signal relative to a local reference point on an antenna array (which may be represented by Cartesian coordinates (x, y, z) or spherical coordinates (ρ, φ, θ)), and location information of an antenna array element used to send the sensing signal in theses selected panels relative to a unified reference point of the panel (for example, a center point of the panel) (which may be represented by Cartesian coordinates (x, y, z) or spherical coordinates (ρ, φ, θ));
(135) bitmap information of an antenna array element, where for example, the bitmap uses “1” to indicate that an array element is selected to send and/or receive the sensing signal, and uses “0” to indicate that an array element is not selected (or vice versa);
(136) bitmap information of an array panel, where for example, the bitmap uses “1” to indicate that a panel is selected to send and/or receive the sensing signal, and uses “0” to indicate that an array element is not selected (or vice versa); and there is bitmap information of an array element in these selected panels; and
(137) threshold information, namely, a threshold used to determine whether an obtained measurement value of a sensing measurement quantity meets the first condition, where thresholds may be different for different candidate nodes and/or candidate tags; there may be more than one sensing measurement quantity and corresponding threshold for any candidate node and/or candidate tag; and the first condition is that a candidate node/candidate tag corresponding to an obtained measurement value of a sensing measurement quantity may be used as a target node/target tag.

For example, the reporting configuration information of the first signal includes at least one of the following:
(1) reporting execution time, including the following types:
(11) periodic reporting: reporting based on a specified time offset and/or period;
(12) semi-persistent reporting: after receiving a report start indication, reporting based on a specified period until receiving a report stop indication; and the report start indication is used to indicate start of a corresponding sensing report, and the report stop indication is used to indicate to stop reporting; and
(13) aperiodic reporting: reporting at a specified moment or in a case that a preset condition is met;
(2) a frequency resource used for reporting; and
(3) channel indication information used for reporting.

Step 4: The third device sends the first signal to the at least one second device based on an indication of the second signaling.

Step 5: The second device receives, based on the first signaling, the first signal sent by the at least one third device, and the second device performs second processing on the first signal (for example, performs second processing on the sensing measurement quantity corresponding to the first signal), and measures the processed first signal to obtain the first result that includes the sensing measurement quantity.

For example, the second processing includes at least one of the following:
(1) processing based on a preset sensing algorithm, where
for example, the sensing algorithm includes but is not limited to MUSIC and the like;
(2) performing clutter elimination on a static object, where
for example, a clutter generated by a static object at a preset location is eliminated, where the preset location may be notified by another device to the first device;
(3) performing clutter elimination on a dynamic non-sensing target, where
for example, a clutter generated by a preset dynamic object is eliminated, where the preset dynamic object is a non-sensing target, and a feature of the preset dynamic object, for example, a Doppler range or a moving speed range, is notified by another device to the first device; and
(4) aligning first paths of the first signal received by a plurality of antennas of the second device.

For example, a specific manner of the second processing and a sensing measurement quantity related to the second processing may be notified by another device to the second device. For example, a core network device notifies a base station (the second device) or a base station notifies UE (the second device).

For example, the first result may include a sensing measurement quantity (namely, a processed sensing measurement quantity).

Step 6: The first device sends format information to the at least one second device, where the format information is used to indicate a format of the first result.

For example, the format information of the first result includes but is not limited to at least one of unified coordinate system information, a unified reference point/origin, or the like used for the first result, where a unified coordinate system may include X/Y/Z in a rectangular coordinate system, or a distance/an azimuth/a pitch angle in a polar coordinate system, or a longitude, a latitude, and an altitude.

Step 7: The at least one second device sends the first result to the first device.

For example, the at least one second device determines, based on the second preset condition, whether to send the first result obtained by the second device to a target device, and the second preset condition is configured by another device for the second device.

For example, the second device sends the confidence level of the first result to the first device, and the confidence level may be determined in at least one of the following manners:

Manner 1: Each second device determines a confidence level of the first result based on a sensing capability of the second device.

Manner 2: The confidence level may, for example, be determined by the first device.

For example, the second device sends at least one of sensing capability information, location information, array orientation information, and the like to the first device. Resolution of the sensing target is different in different orientation arrays, and confidence levels of the corresponding first result are also different. For example, the sensing target is located in an antenna normal direction, and a confidence level of the first result corresponding to the sensing target is maximum.

Step 8: The first device performs first processing on at least two first results, to obtain a second result.

For example, the first device determines whether the first result meets a first preset condition. If the first device determines that the first result meets the first preset condition, the first device performs first processing on the first result, to obtain the second result.

For example, the first preset condition is configured by another device for the first device, for example, is configured by a core network device for a base station; or the first preset condition is determined by the second device based on the sensing requirement.

For example, the second result may include a sensing measurement quantity (namely, a processed sensing measurement quantity).

Step 9: If the first device is not a core network device, the first device sends the second result to the core network device.

For example, the first device may re-broadcast the first device and the second device that participate in cooperative sensing. In this way, some cooperative devices with low confidence levels may quit cooperative sensing, or a new sensing node/sensing device may be re-selected to participate in cooperative sensing, to reduce overheads and computing power.

Step 10: The core network device sends the second result to a sensing requirement side.

For example, the sensing requirement side includes an external application server.

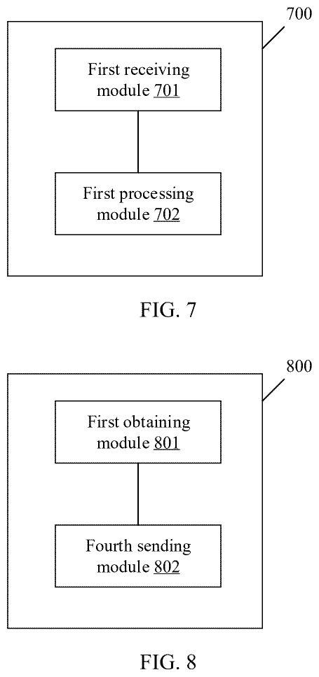

Referring to FIG. 7, an embodiment of this application provides a sensing processing apparatus, used in a first device. The first device may be a core network device, a base station, or a device that sends a first signal. The device that sends the first signal may be a terminal or a base station. The apparatus 700 includes:
a first receiving module 701, configured to receive a first result sent by at least one second device, where the first result includes a sensing measurement quantity obtained by the second device by measuring a first signal, from a third device, used for a sensing service; and
a first processing module 702, configured to perform first processing on at least two first results, to obtain a second result.

For example, the first processing includes at least one of the following:
(1) obtaining an average value of the at least two first results;
(2) obtaining a weighted average value of the at least two first results;
(3) obtaining a value whose specified indicator is optimal in the at least two first results;
(4) selecting, from the at least two first results associated with a same sensing target or a same sensing area or a same sensing service, first results corresponding to different sensing measurement quantities; and
(5) fusing the at least two first results associated with the same sensing target or the same sensing area or the same sensing service.

In an implementation of this application, a determining manner of the at least two first results associated with the same sensing target or the same sensing area or the same sensing service includes at least one of the following:
in a global coordinate system or a same coordinate system, if location coordinates corresponding to the at least two first results are the same or similar, the at least two first results are associated with the same sensing target or the same sensing area or the same sensing service; or
in a global coordinate system or a same coordinate system, if location coordinates corresponding to the at least two first results are the same and corresponding moving speeds are the same or similar, the at least two first results are associated with the same sensing target or the same sensing area or the same sensing service.

In an implementation of this application, the apparatus further includes:
a first sending module, configured to send format information to the at least one second device, where the format information is used to indicate a format of the first result.

In an implementation of this application, the apparatus further includes:
a second receiving module, configured to receive a confidence level of the first result sent by the at least one second device;
and/or
a third receiving module, configured to receive at least one of sensing capability information, location information, and array orientation information sent by the at least one second device; and
a determining module, configured to determine the confidence level of the first result based on at least one of the sensing capability information, the location information, and the array orientation information.

In an implementation of this application, the first processing module 702 is further configured to:
in a case that the sensing measurement quantity or sensing performance corresponding to an operation result of the sensing measurement quantity meets a first preset condition, perform first processing on the at least two first results, to obtain the second result.

In an implementation of this application, that the sensing measurement quantity or the sensing performance meets the first preset condition includes at least one of the following:
a power value of a sensing target association signal component meets a first threshold;
a sensing SNR meets a second threshold;
a sensing SINR meets a third threshold;
at least Y sensing targets are detected, where Y is a positive integer;
a bitmap corresponding to a sensing target determined based on detection is consistent with a preset bitmap configured by a network side device;
an RCS of the sensing target meets a third preset condition;
spectral information of the sensing target meets a fourth preset condition; and
a first parameter of the sensing target meets a fifth preset condition, and the first parameter includes at least one of the following: a delay, a distance, Doppler, a speed, and angle information.

In an implementation of this application, the sensing measurement quantity includes at least one of the following:
a first-level measurement quantity, where the first-level measurement quantity includes at least one of a received signal/channel response complex result, an amplitude/phase, and I channels/Q channels and operation results of the I channels/Q channels;
a second-level measurement quantity, where the second-level measurement quantity includes at least one of a delay, Doppler, an angle, and strength;
a third-level measurement quantity, where the third-level measurement quantity includes at least one of a distance, a speed, an orientation, a spatial position, and acceleration; and
a fourth-level measurement quantity, where the fourth-level measurement quantity includes at least one of whether a target exists, a trajectory, an action, an expression, a vital sign, a quantity, an imaging result, weather, air quality, a shape, a material, and a composition.

In an implementation of this application, the sensing measurement quantity further includes tag information corresponding to the sensing measurement quantity, where
the tag information includes at least one of the following:
sensing signal identification information;
sensing measurement configuration identification information;
sensing service information;
a data subscription identifier;
measurement quantity usage;
time information;
sensing node information;
sensing link information;
measurement quantity description information;
a measurement quantity form; and
measurement quantity indicator information.

In an implementation of this application, the apparatus further includes:
a second sending module, configured to send the second result to a core network device.

In an implementation of this application, the apparatus further includes:
a third sending module, configured to broadcast sensing node information used to receive and/or send the first signal.

In an implementation of this application, the second device or the third device is associated with at least one sensing manner, and the sensing manner includes at least one of base station self-sending and self-receiving sensing, inter-base station air interface sensing, uplink air interface sensing, downlink air interface sensing, terminal self-sending and self-receiving sensing, and inter-terminal sidelink sensing.

Referring to FIG. 8, an embodiment of this application provides a sensing processing apparatus, used in a second device. The second device may be a device that receives a first signal. For example, the second device may be a base station or a terminal. The apparatus 800 includes:
a first obtaining module 801, configured to obtain a first result, where the first result includes a sensing measurement quantity obtained by the second device by measuring a first signal, sent by at least one third device, used for a sensing service; and
a fourth sending module 802, configured to send the first result to a first device, where the first result is used to obtain a second result through first processing.

In an implementation of this application, the first processing includes at least one of the following:
(1) obtaining an average value of at least two first results;
(2) obtaining a weighted average value of the at least two first results;
(3) obtaining a value whose specified indicator is optimal in the at least two first results;
(4) selecting, from the at least two first results associated with a same sensing target or a same sensing area or a same sensing service, first results corresponding to different sensing measurement quantities; and
(5) fusing the at least two first results associated with the same sensing target or the same sensing area or the same sensing service.

In an implementation of this application, a determining manner of the at least two first results associated with the same sensing target or the same sensing area or the same sensing service includes at least one of the following:
in a global coordinate system or a same coordinate system, if location coordinates corresponding to the at least two first results are the same or similar, the at least two first results are associated with the same sensing target or the same sensing area or the same sensing service; or
in a global coordinate system or a same coordinate system, if location coordinates corresponding to the at least two first results are the same and corresponding moving speeds are the same or similar, the at least two first results are associated with the same sensing target or the same sensing area or the same sensing service.

In an implementation of this application, the apparatus further includes:
a second processing module, configured to perform second processing on the first signal, where
the second processing includes at least one of the following:
(1) processing based on a sensing algorithm;
(2) performing clutter elimination on a static object;
(3) performing clutter elimination on a dynamic non-sensing target; and
(4) aligning first paths of the first signal received by a plurality of antennas of the second device.

In an implementation of this application, the apparatus further includes:
a fifth receiving module, configured to receive format information sent by the first device, where the format information is used to indicate a format of the first result.

In an implementation of this application, the apparatus further includes:
a determining module, configured to determine a confidence level of the first result based on a sensing capability of the second device;
a fifth sending module, configured to send the confidence level of the first result to the first device;
and/or
a sixth sending module, configured to send at least one of sensing capability information, location information, and array orientation information of the second device to the first device, where at least one of the sensing capability information, the location information, and the array orientation information is used to determine the confidence level of the first result.

In an implementation of this application, the fourth sending module 802 is further configured to: in a case that the sensing measurement quantity or sensing performance corresponding to an operation result of the sensing measurement quantity meets a second preset condition, send the first result to the first device.

In an implementation of this application, that the sensing measurement quantity or the sensing performance meets the second preset condition includes at least one of the following:
a power value of a sensing target association signal component meets a fourth threshold;
a sensing SNR meets a fifth threshold;
a sensing SINR meets a sixth threshold;
at least Z sensing targets are detected, where Z is a positive integer;
a bitmap corresponding to a sensing target determined based on detection is consistent with a preset bitmap configured by a network side device;
an RCS of the sensing target meets a sixth preset condition;
spectral information of the sensing target meets a seventh preset condition; and
a first parameter of the sensing target meets an eighth preset condition, and the first parameter includes at least one of the following: a delay, a distance, Doppler, a speed, and angle information.

In an implementation of this application, the apparatus further includes:
a sixth receiving module, configured to receive first signaling, where the first signaling indicates at least one of the following:
(1) the first signal received by the second device;
(2) the sensing measurement quantity of the first signal;
(3) tag information corresponding to the sensing measurement quantity of the first signal; and
(4) reporting configuration information of the first signal.

In an implementation of this application, the sensing measurement quantity includes at least one of the following:
a first-level measurement quantity, where the first-level measurement quantity includes at least one of a received signal/channel response complex result, an amplitude/phase, and I channels/Q channels and operation results of the I channels/Q channels;
a second-level measurement quantity, where the second-level measurement quantity includes at least one of a delay, Doppler, an angle, and strength;
a third-level measurement quantity, where the third-level measurement quantity includes at least one of a distance, a speed, an orientation, a spatial position, and acceleration; and
a fourth-level measurement quantity, where the fourth-level measurement quantity includes at least one of whether a target exists, a trajectory, an action, an expression, a vital sign, a quantity, an imaging result, weather, air quality, a shape, a material, and a composition.

In an implementation of this application, the sensing measurement quantity further includes tag information corresponding to the sensing measurement quantity, where
the tag information includes at least one of the following:
sensing signal identification information;
sensing measurement configuration identification information;
sensing service information;
a data subscription identifier;
measurement quantity usage;
time information;
sensing node information;
sensing link information;
measurement quantity description information;
a measurement quantity form; and
measurement quantity indicator information.

In an implementation of this application, the second device or the third device is associated with at least one sensing manner, and the sensing manner includes at least one of base station self-sending and self-receiving sensing, inter-base station air interface sensing, uplink air interface sensing, downlink air interface sensing, terminal self-sending and self-receiving sensing, and inter-terminal sidelink sensing.

The apparatus provided in this embodiment of this application can implement the processes implemented in the method embodiment of FIG. 3, and a same technical effect is achieved. To avoid repetition, details are not described herein again.

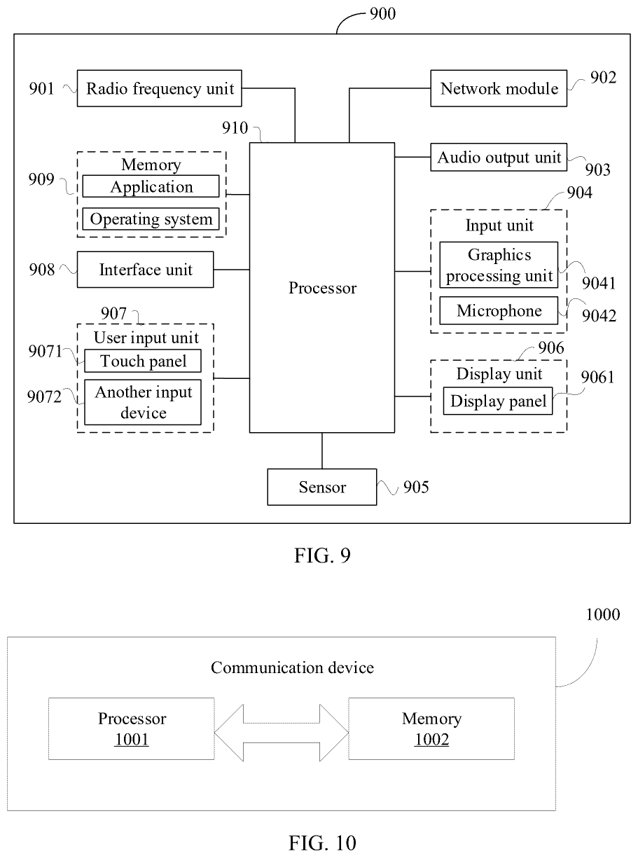

An embodiment of this application further provides a terminal. For example, FIG. 9 is a schematic diagram of a hardware structure of a terminal according to an embodiment of this application.

The terminal 900 includes but is not limited to at least a part of components such as a radio frequency unit 901, a network module 902, an audio output unit 903, an input unit 904, a sensor 905, a display unit 906, a user input unit 907, an interface unit 908, a memory 909, and a processor 910.

A person skilled in the art can understand that the terminal 900 may further include a power supply (such as a battery) that supplies power to each component. The power supply may be logically connected to the processor 910 by using a power supply management system, to implement functions such as charging and discharging management, and power consumption management by using the power supply management system. The terminal structure shown in FIG. 9 constitutes no limitation on the terminal, and the terminal may include more or fewer components than those shown in the figure, or combine some components, or have different component arrangements. Details are not described herein.

It should be understood that in this embodiment of this application, the input unit 904 may include a Graphics Processing Unit (GPU) 9041 and a microphone 9042. The graphics processing unit 9041 processes image data of a static picture or a video obtained by an image capture apparatus (for example, a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 and another input device 9072. The touch panel 9071 is also referred to as a touchscreen. The touch panel 9071 may include two parts: a touch detection apparatus and a touch controller. The another input device 9072 may include but is not limited to a physical keyboard, a functional button (such as a volume control button or a power on/off button), a trackball, a mouse, and a joystick. Details are not described herein.

In this embodiment of this application, after receiving downlink data from a network device, the radio frequency unit 901 may transmit the downlink data to the processor 910 for processing. In addition, the radio frequency unit 901 may send uplink data to the network device. Usually, the radio frequency unit 901 includes but is not limited to an antenna, an amplifier, a transceiver, a coupler, a low noise amplifier, a duplexer, and the like.

The memory 909 may be configured to store a software program or an instruction and various data. The memory 909 may mainly include a first storage area for storing a program or an instruction and a second storage area for storing data. The first storage area may store an operating system, and an application or an instruction required by at least one function (for example, a sound playing function or an image playing function). In addition, the memory 909 may be a volatile memory or a non-volatile memory, or the memory 909 may include a volatile memory and a non-volatile memory. The non-volatile memory may be a Read-Only Memory (ROM), a programmable read-only memory (PROM), an erasable programmable read-only memory (EPROM), an electrically erasable programmable read-only memory (EEPROM), or a flash memory. The volatile memory may be a Random Access Memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 909 in this embodiment of this application includes but is not limited to these memories and any memory of another proper type.

The processor 910 may include one or more processing units. For example, an application processor and a modem processor are integrated into the processor 910. The application processor mainly processes an operating system, a user interface, an application, or the like. The modem processor mainly processes a wireless communication signal, for example, a baseband processor. It may be understood that, for example, the modem processor may not be integrated into the processor 910.

The terminal provided in this embodiment of this application can implement the processes implemented in the method embodiment of FIG. 2, and a same technical effect is achieved. To avoid repetition, details are not described herein again.

For example, as shown in FIG. 10, an embodiment of this application further provides a communication device 1000. The communication device 1000 includes a processor 1001 and a memory 1002. The memory 1002 stores a program or an instruction that is executable on the processor 1001. For example, when the communication device 1000 is a terminal, the program or the instruction is executed by the processor 1001 to implement steps in the method embodiment of FIG. 2, and a same technical effect can be achieved. When the communication device 1000 is a network device, the program or the instruction is executed by the processor 1001 to implement steps in the method embodiment of FIG. 3, and a same technical effect can be achieved. To avoid repetition, details are not described herein again.

An embodiment of this application further provides a readable storage medium. The readable storage medium stores a program or an instruction; and when the program or the instruction is executed by a processor, the processes of the method in FIG. 2 or FIG. 3 and in the foregoing embodiments are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, the processor is configured to run a program or an instruction to implement the processes in FIG. 2 or FIG. 3 and in the foregoing method embodiments, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, the computer program/program product is executed by at least one processor to implement the processes in FIG. 2 or FIG. 3 and in the foregoing method embodiments, and a same technical effect can be achieved. To avoid repetition, details are not described herein again.

An embodiment of this application further provides a communication system. The communication system includes a terminal and a network device. The terminal is configured to perform the processes in FIG. 2 and in the foregoing method embodiments, the network device is configured to perform the processes in FIG. 3 and in the foregoing method embodiments, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and apparatus in the embodiments of this application is not limited to performing functions in the order shown or discussed, but may also include performing the functions in a basically simultaneous manner or in opposite order based on the functions involved. For example, the described method may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiments may be implemented by software in addition to a necessary universal hardware platform or by hardware only. In most circumstances, the former is an example implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the method described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A sensing processing method, comprising:
receiving, by a first device, a first result sent by at least one second device, wherein the first result comprises a sensing measurement quantity obtained by the second device by measuring a first signal, from a third device, used for a sensing service; and
performing, by the first device, first processing on at least two first results, to obtain a second result.

2. The method according to claim 1, wherein the first processing comprises at least one of the following:
obtaining an average value of the at least two first results;
obtaining a weighted average value of the at least two first results;
obtaining a value whose specified indicator is optimal in the at least two first results;
selecting, from the at least two first results associated with a same sensing target or a same sensing area or a same sensing service, first results corresponding to different sensing measurement quantities; or
fusing the at least two first results associated with the same sensing target or the same sensing area or the same sensing service.

3. The method according to claim 2, wherein a determining manner of the at least two first results associated with the same sensing target or the same sensing area or the same sensing service comprises at least one of the following:
in a global coordinate system or a same coordinate system, when location coordinates corresponding to the at least two first results are the same, the at least two first results are associated with the same sensing target or the same sensing area or the same sensing service; or
in a global coordinate system or a same coordinate system, when location coordinates corresponding to the at least two first results are the same and corresponding moving speeds are the same, the at least two first results are associated with the same sensing target or the same sensing area or the same sensing service.

4. The method according to claim 1, further comprising:
sending, by the first device, format information to the at least one second device, wherein the format information is used to indicate a format of the first result.

5. The method according to claim 1, further comprising at least one of the following:
receiving, by the first device, a confidence level of the first result sent by the at least one second device; or
receiving, by the first device, at least one of sensing capability information, location information, and array orientation information sent by the at least one second device, wherein at least one of the sensing capability information, the location information, and the array orientation information is used to determine the confidence level of the first result.

6. The method according to claim 1, wherein the performing, by the first device, first processing on at least two first results, to obtain a second result comprises:
when the sensing measurement quantity or sensing performance corresponding to an operation result of the sensing measurement quantity meets a first preset condition, performing, by the first device, first processing on the at least two first results, to obtain the second result.

7. The method according to claim 6, wherein that the sensing measurement quantity or the sensing performance meets the first preset condition comprises at least one of the following:
a power value of a sensing target association signal component meets a first threshold;
a sensing signal-to-noise ratio (SNR) meets a second threshold;
a sensing signal-to-noise and interference ratio (SINR) meets a third threshold;
at least Y sensing targets are detected, wherein Y is a positive integer;
a bitmap corresponding to a sensing target determined based on detection is consistent with a preset bitmap configured by a network side device;
a radar cross section (RCS) of the sensing target meets a third preset condition;
spectral information of the sensing target meets a fourth preset condition; or
a first parameter of the sensing target meets a fifth preset condition, and the first parameter comprises at least one of the following: a delay, a distance, Doppler, a speed, or angle information.

8. The method according to claim 1, wherein the sensing measurement quantity comprises at least one of the following:
a first-level measurement quantity, wherein the first-level measurement quantity comprises at least one of a received signal/channel response complex result, an amplitude/phase, and I channels/Q channels and operation results of the I channels/Q channels;
a second-level measurement quantity, wherein the second-level measurement quantity comprises at least one of a delay, Doppler, an angle, and strength;
a third-level measurement quantity, wherein the third-level measurement quantity comprises at least one of a distance, a speed, an orientation, a spatial position, and acceleration; or
a fourth-level measurement quantity, wherein the fourth-level measurement quantity comprises at least one of whether a target exists, a trajectory, an action, an expression, a vital sign, a quantity, an imaging result, weather, air quality, a shape, a material, and a composition.

9. The method according to claim 8, wherein the sensing measurement quantity further comprises tag information corresponding to the sensing measurement quantity, wherein the tag information comprises at least one of the following:
sensing signal identification information;
sensing measurement configuration identification information;
sensing service information;
a data subscription identifier;
measurement quantity usage;
time information;
sensing node information;
sensing link information;
measurement quantity description information;
a measurement quantity form; or
measurement quantity indicator information.

10. The method according to claim 1, wherein after the performing, by the first device, first processing on at least two first results, to obtain a second result, the method further comprises:
sending, by the first device, the second result to a core network device.

11. The method according to claim 1, after the receiving, by a first device, a first result sent by at least one second device, the method further comprises:
broadcasting, by the first device, sensing node information used to receive or send the first signal.

12. The method according to claim 1, wherein the second device or the third device is associated with at least one sensing manner, and the sensing manner comprises at least one of base station self-sending and self-receiving sensing, inter-base station air interface sensing, uplink air interface sensing, downlink air interface sensing, terminal self-sending and self-receiving sensing, or inter-terminal sidelink sensing.

13. A sensing processing method, comprising:
obtaining, by a second device, a first result, wherein the first result comprises a sensing measurement quantity obtained by the second device by measuring a first signal, sent by at least one third device, used for a sensing service; and
sending, by the second device, the first result to a first device, wherein the first result is used to obtain a second result through first processing.

14. The method according to claim 13, wherein the first processing comprises at least one of the following:
obtaining an average value of at least two first results;
obtaining a weighted average value of the at least two first results;
obtaining a value whose specified indicator is optimal in the at least two first results;
selecting, from the at least two first results associated with a same sensing target or a same sensing area or a same sensing service, first results corresponding to different sensing measurement quantities; or
fusing the at least two first results associated with the same sensing target or the same sensing area or the same sensing service.

15. The method according to claim 13, wherein a determining manner of at least two first results associated with a same sensing target or a same sensing area or a same sensing service comprises at least one of the following:
in a global coordinate system or a same coordinate system, when location coordinates corresponding to the at least two first results are the same, the at least two first results are associated with the same sensing target or the same sensing area or the same sensing service; or
in a global coordinate system or a same coordinate system, when location coordinates corresponding to the at least two first results are the same and corresponding moving speeds are the same, the at least two first results are associated with the same sensing target or the same sensing area or the same sensing service.

16. The method according to claim 13, wherein before the second device measures the first signal to obtain the first result, the method further comprises:
performing, by the second device, second processing on the first signal,
wherein the second processing comprises at least one of the following:
processing based on a specified sensing algorithm;
performing clutter elimination on a static object;
performing clutter elimination on a dynamic non-sensing target; or
aligning first paths of the first signal received by a plurality of antennas of the second device.

17. The method according to claim 13, further comprising:
receiving, by the second device, format information sent by the first device, wherein the format information is used to indicate a format of the first result.

18. The method according to claim 13, further comprising:
determining, by the second device, a confidence level of the first result based on a sensing capability, and sending, by the second device, the confidence level of the first result to the first device; or
sending, by the second device, at least one of sensing capability information, location information, and array orientation information of the second device to the first device, wherein at least one of the sensing capability information, the location information, and the array orientation information is used to determine the confidence level of the first result.

19. The method according to claim 13, wherein the sending, by the second device, the first result to a first device comprises:
when the sensing measurement quantity or sensing performance corresponding to an operation result of the sensing measurement quantity meets a second preset condition, sending, by the second device, the first result to the first device.

20. A communication device, comprising:
a processor; and
a memory storing a program or an instruction that, when executed by the processor, causes the communication device to perform operations comprising:
receiving a first result sent by at least one second device, wherein the first result comprises a sensing measurement quantity obtained by the second device by measuring a first signal, from a third device, used for a sensing service; and
performing first processing on at least two first results, to obtain a second result.
